(19) United States
(12) Patent Application Publication
(10) Pub. No.: US 2004/0213734 A1
(43) Pub. Date: Oct. 28, 2004

(54) Method and device for producing a desulphurised fuel gas for fuel cells

(76) Inventor: Manfred Bischoff, Feldkirchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/487,355

(22) PCT Filed: Aug. 21, 2002
(86) PCT No.: PCT/EP02/09317

(30) Foreign Application Priority Data
Aug. 23, 2001 (DE) 10141355.6

(51) Int. Cl. C01B 3/24; B01J 8/04

(52) U.S. Cl. 423/650; 422/105; 422/190

(57) ABSTRACT

A method and device for producing a desulfurized fuel gas for fuel cells, wherein the fuel gas, such as natural gas, is desulfurized in a desulfurization device and the sulfur content of the desulfurized fuel gas is monitored. At least one partial flow of desulfurized fuel gas is guided through a reforming catalyst and is subjected to reforming process. The course of the reforming process is monitored, with a decrease in the reforming process indicating an increase in the sulfur content of the fuel gas.

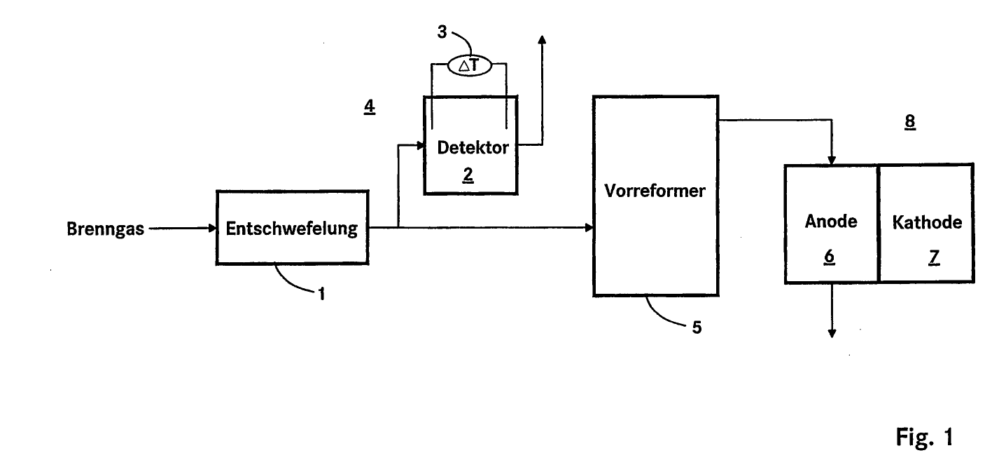

This application claims the priority of DE 101 41 355.6, filed Aug. 23, 2001, the disclosure of which is expressly incorporated by reference herein.

The invention relates to a method of producing a desulfurized fuel gas for fuel cells, in which the fuel gas, particularly natural gas, is desulfurized and the sulfur content of the desulfurized fuel gas is monitored. Furthermore, the invention relates to a device for producing a desulfurized fuel gas for fuel cells having a desulfurization device through which the fuel gas, particularly the natural gas, flows and having a detector device, which is connected behind the desulfurization device, for monitoring the sulfur content of the desulfurized fuel gas.

### BACKGROUND OF THE INVENTION

During the operation of fuel cells, there is a risk that the reforming catalysts used for the pretreatment of the fuel gas may be deactivated by sulfur contained in the fuel gas and may be irreversibly damaged. For this reason, desulfurization devices in the form of, for example, activated carbon filters are connected in front of the reforming catalysts. In the course of operation, these filters are subject to a depletion connected with a decline of the desulfurization capacity. Some previous methods have tried to calculate the service life of a filter based on the absorption capacity of the filter material, the quantity of gas carried through the filter, and the sulfur content in the untreated fuel gas. However, this method of calculating the service life is highly unreliable because of fluctuations of the sulfur content in the fuel gas and because of not precisely known influences of additional constituents of the fuel gas on the absorption behavior of the filter material. Continuous monitoring of the sulfur content of the fuel gas by means of conventional analyzing equipment and its integration over the time requires high technical expenditures and is not advantageous for reasons of cost. Because of the consequences in the event of a sulfur breakthrough to the fuel cells, reliable monitoring of the fuel gas with respect to its sulfur content is important when producing fuel gas.

U.S. Pat. No. 5,213,912 describes a fuel cell arrangement with a desulfurization device which is formed by a sorption filter. When the filter is saturated with sulfur constituents, the filter should be exchanged or regenerated.

European Patent Document EP 0 565 025 A1 describes a method of producing a desulfurized fuel gas for fuel cells in which the fuel gas is desulfurized by means of a copper nickel alloy.

### SUMMARY OF THE INVENTION

It is an object of the invention to provide a method and a device for producing a desulfurized fuel gas for fuel cells in which the fuel gas, particularly natural gas, is desulfurized and the sulfur content of the desulfurized fuel gas is monitored, in which the monitoring of the fuel gas with respect to its sulfur content takes place in a simple and reliable manner.

These and other objects and advantages of the invention are achieved by a method according to the invention for producing a desulfurized fuel gas for fuel cells. In an embodiment, the fuel gas, particularly natural gas, is desulfurized and the sulfur content of the desulfurized fuel gas is monitored. At least a partial flow of the desulfurized fuel gas is guided through a reforming catalyst and is subjected to a reforming process. The course of the reforming process is monitored, and a decline of the reforming process is assessed as a signal of a rise of the sulfur content of the fuel gas.

In an embodiment, an advantage of the method according to the invention is that the risk of an irreversible damage to the fuel gas catalysts is largely reduced and thus the operating reliability of the system is increased significantly. Another advantage is that the used filter material can be utilized in an optimal manner. Additionally, the method of the invention can be implemented in a cost-effective manner.

In some preferred embodiments of the invention, monitoring the course of the reforming process comprises measuring its heat requirement.

In an embodiment, the (endothermic) reforming process is carried out adiabatically and in the process the temperature decrease ΔT of the fuel gas is measured.

In another embodiment, a reduction of the temperature decrease AT is evaluated as a measurement corresponding to a rise of the sulfur content in the fuel gas.

When the temperature decrease ΔT falls below a defined value ΔTₗᵢₘᵢₜ, an alarm signal is preferably given.

In still another embodiment of the invention, the (endothermic) reforming process is carried out isothermically while heat is supplied and in the process the supplied heat quantity ΔQ is measured.

In such an embodiment, a decrease of the supplied heat quantity ΔQ can be evaluated as a measurement corresponding to a rise of the sulfur content in the fuel gas.

In yet another embodiment, heat is supplied by electric heating and the applied electric power is measured for determining the supplied heat quantity ΔQ.

Preferably, when the supplied heat quantity ΔQ falls below a defined value ΔQₗᵢₘᵢₜ, an alarm signal is given.

Preferably, in the event of the occurrence of the alarm signal, the production of the fuel gas is interrupted or a measure is taken for improving the desulfurization of the fuel gas.

In an embodiment, this invention also provides, a device for producing a desulfurized fuel gas, particularly natural gas, for fuel cells. The device comprises a desulfurization device, through which the fuel gas flows, and a detector device for monitoring the sulfur content of the desulfurized fuel gas which is connected behind the desulfurization device. According to the invention, the detector device comprises a reforming catalyst, through which at least a partial flow of the desulfurized fuel gas flows, and a monitoring device, which is coupled with the reforming catalyst, for monitoring the course of the reforming process taking place in the reforming catalyst. The monitoring device is constructed such that, as a response to the decline of the reforming process, it generates a signal representing the rise of the sulfur content of the fuel gas.

According to a preferred embodiment of the invention, the monitoring device is constructed such that the course of the reforming process is monitored by measuring its heat requirement.

According to another embodiment of the invention, the reforming catalyst is constructed for the adiabatic implementation of the (adiabatic) reforming process, and the monitoring device comprises devices for measuring the temperature decrease ΔT of the fuel gas.

In an embodiment, the monitoring device is preferably constructed such that a reduction of the temperature decrease ΔT is evaluated as a measurement for a rise of the sulfur content in the fuel gas.

The monitoring device also preferably contains devices for generating an alarm signal when the temperature decrease ΔT falls below a defined value ΔTₗᵢₘᵢₜ.

According to an alternative embodiment of the invention, the reforming catalyst is constructed for the isothermic implementation of the (endothermic) reforming process while heat is supplied, and the monitoring device comprises devices for measuring the heat quantity ΔQ supplied to the reforming process.

In an embodiment, the monitoring device is preferably constructed such that a reduction of the supplied heat quantity ΔQ is evaluated as a measurement for a rise of the sulfur content in the fuel gas.

In still another embodiment, the detector device contains devices for supplying the heat to the reforming catalyst by electric heating, and the monitoring device is constructed for determining the supplied heat quantity ΔQ by measuring the applied electric power.

In an embodiment, the monitoring device preferably contains devices for generating an alarm signal when the supplied heat quantity ΔQ falls below a defined value ΔQₗᵢₘᵢₜ.

According to a preferred embodiment of the invention, the reforming catalyst of the detector device is provided as a separate catalyst.

According to another embodiment of the invention, the reforming catalyst of the detector device is a component of a reforming catalyst connected in front of the fuel cells and used for reforming the fuel gas supplied to the fuel cells, or is formed by this reforming catalyst.

In the following, embodiments of the invention will be explained by means of the drawing. Other objects, advantages and novel features of the present invention will become apparent from the following detailed description of the invention when considered in conjunction with the accompanying drawing.

### BRIEF DESCRIPTION OF THE FIGURE

The FIGURE is a schematic connection diagram of a fuel cell arrangement, in which the fuel gas is generated while being desulfurized and while the sulfur content of the desulfurized fuel gas is monitored, according to embodiments of the invention.

### DETAILED DESCRIPTION OF THE EMBODIMENTS

The FIGURE illustrates a fuel cell arrangement which shows one fuel cell 8 containing an anode 6 and a cathode, which represents typically a number of fuel cells arranged in a fuel cell stack. A reforming catalyst 5 is connected in front of the fuel cell 8, in which the fuel gas used for the operation of the fuel cells is subjected to a reforming process. A desulfurization device 1 is connected in front of the reforming catalyst 5, which desulfurization device 1 has the purpose of reducing a content of sulfur or sulfur compounds contained in the fuel gas. The fuel gas, which may be present particularly in the form of natural gas, is supplied to the arrangement at B.

A device for producing a desulfurized fuel gas therefore contains a desulfurization device 1, through which the fuel gas flows, and a detector device, which is connected behind the desulfurization device 1 and, on the whole, has the reference number 4, which detector device is used for monitoring the sulfur content of the desulfurized fuel gas.

The detector device comprises a reforming catalyst 2, through which a partial flow of the desulfurized and additionally moistened fuel gas flows, and a monitoring device 3 coupled with this reforming catalyst 2, for monitoring the course of the reforming process taking place in the reforming catalyst 2. The monitoring device 3 is constructed such that, as a response to a decline of the reforming process, it generates a signal representing the rise of the sulfur content of the fuel gas. In order to monitor the course of the reforming process, its heat requirement is measured.

According to a first embodiment of the invention, the reforming catalyst 2 is constructed for the adiabatic implementation of the endothermic reforming process, and the monitoring device 3 comprises devices for measuring the temperature decrease ΔT of the fuel gas during this process. The monitoring device 3 is constructed such that a reduction of the temperature decrease ΔT is evaluated as a measurement for a rise of the sulfur content in the fuel gas.

Furthermore, the monitoring device 3 contains devices for generating an alarm signal when the temperature decrease ΔT falls below a defined value ΔTₗᵢₘᵢₜ. When the alarm signal occurs, the production of the fuel gas can be interrupted or a measure can be taken for improving the desulfurization of the fuel gas.

According to a second embodiment of the invention, the reforming catalyst 2 is constructed for the isothermic implementation of the reforming process while heat is supplied, and the monitoring device 3 comprises devices for measuring the supplied heat quantity ΔQ. The monitoring device 3 is constructed such that a reduction of the supplied heat quantity ΔQ is evaluated as a measurement for a rise of the sulfur content in the fuel gas.

In the case of the embodiment described here, the detector device 4 (not shown in the FIGURE) contains devices for supplying heat to the reforming catalyst 2 by electric heating, and the monitoring device 3 is constructed for determining the supplied heat quantity ΔQ by measuring the applied electric power.

Here also, the monitoring device 3 contains devices for generating an alarm signal when the supplied heat quantity ΔQ falls below a defined value ΔQₗᵢₘᵢₜ. When the alarm signal occurs, the production of the fuel gas can be interrupted or a measure can be taken for improving the desulfurization of the fuel gas.

As in the two above-described embodiments of the invention, the reforming catalyst 2 of the detector device 4 can be provided as a separate catalyst which is used only for monitoring the sulfur content of the fuel gas. The fuel gas leaving the reforming catalyst 2, which represents only a small partial flow of the entire fuel gas flow, can either remain unused or can be supplied to the reforming catalyst 5 or directly to the anode 6 of the fuel cell 8 and can thereby also be utilized.

As an alternative, the reforming catalyst 2 of the detector device 4 can be provided as a component of a reforming catalyst 5 connected in front of the fuel cells and used for the actual reforming of the fuel gas required for the operation of the fuel cells, or can be formed by this reforming catalyst 5.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-20. (canceled)

21. A method of producing a desulfurized fuel gas for fuel cells, comprising:
desulfurizing a fuel gas;
supplying the fuel gas to a reforming catalyst; and
monitoring the course of a reforming process in order to monitor the sulfur content of the desulfurized fuel gas,
wherein monitoring the course of said reforming process comprises:
guiding a partial flow of the desulfurized fuel gas through a separate reforming catalyst in a detector device; and
subjecting the partial flow to an endothermic reforming process;
wherein a decline in a heat requirement for the endothermic reforming process is evaluated as a signal for a rise of the sulfur content of the fuel gas.

22. A method according to claim 21, wherein monitoring the course of the reforming process comprises measuring the heat requirement of the endothermic reforming process.

23. A method according to claim 22, wherein said endothermic reforming process is carried out adiabatically and measuring the heat requirement comprises measuring the temperature decrease ΔT of the fuel gas.

24. A method according to claim 23, wherein a reduction in the temperature decrease ΔT is evaluated as a measurement for a rise of the sulfur content in the fuel gas.

25. A method according to claim 24, wherein an alarm signal is given when the value of the temperature decrease ΔT falls below a defined value ΔTₗᵢₘᵢₜ.

26. A method according to claim 22, wherein the reforming process is carried out while heat is supplied isothermically and wherein measuring the heat requirement comprises measuring the supplied heat quantity ΔQ.

27. A method according to claim 26, wherein a reduction of the supplied heat quantity ΔQ is evaluated as a measurement for a rise of the sulfur content in the fuel gas.

28. A method according to claim 26, wherein heat is supplied by electric heating and wherein measuring the supplied heat quantity ΔQ comprises measuring the applied electric power.

29. A method according to claim 27, wherein an alarm signal is given when the value of the supplied heat quantity ΔQ falls below a defined value ΔQₗᵢₘᵢₜ.

30. A method according to claim 25, wherein when the alarm signal occurs, the production of the fuel gas is interrupted or a measure is taken for improving the desulfurization of the fuel gas.

31. A method according to claim 29, wherein when the alarm signal occurs, the production of the fuel gas is interrupted or a measure is taken for improving the desulfurization of the fuel gas.

32. A method according to claim 21, wherein the fuel gas is natural gas.

33. A device for producing a desulfurized fuel gas for fuel cells, comprising:
a desulfurization device;
a reforming catalyst connected to said desulfurization device that receives fuel gas that flows through the desulfurization device; and
a detector device connected to said desulfurization device for monitoring the sulfur content of the desulfurized fuel gas,
wherein the detector device comprises:
a second reforming catalyst for receiving a partial flow of desulfurized fuel gas from the desulfurization device; and
a monitoring device to monitor the course of an endothermic reforming process taking place in the second reforming catalyst, wherein the monitoring device is capable, in response to a decline in the endothermic reforming process, of generating a signal representing an increase of sulfur content in the fuel gas.

34. A device according to claim 33, wherein the monitoring device monitors the course of the reforming process by measuring a heat requirement of the reforming process.

35. A device according to claim 34, wherein the second reforming catalyst is constructed for adiabatic implementation of the reforming process, and wherein the monitoring device comprises one or more devices for measuring the temperature decrease ΔT of the fuel gas.

36. A device according to claim 35, wherein the monitoring device is constructed such that a reduction of the temperature decrease ΔT is evaluated as corresponding to a rise of the sulfur content in the fuel gas.

37. A device according to claim 36, wherein the monitoring device further comprises one or more devices for generating an alarm signal when the temperature decrease ΔT falls below a defined value ΔTₗᵢₘᵢₜ.

38. A device according to claim 34, wherein the reforming catalyst is constructed for the isothermic implementation of the reforming process while heat is supplied, and in that the monitoring device comprises one or more devices for measuring the supplied heat quantity ΔQ.

39. A device according to claim 38, wherein the monitoring device is constructed such that a reduction of the supplied heat quantity ΔQ is evaluated as corresponding to a rise of the sulfur content in the fuel gas.

40. A device according to claim 38, wherein the detector device comprises devices for supplying the heat to the reforming catalyst by electric heating, and in that the monitoring device is constructed for determining the supplied heat quantity ΔQ by measuring the applied electric power.

41. A device according to claim 39, wherein the monitoring device comprises devices for generating an alarm signal when the supplied heat quantity ΔQ falls below a defined value ΔQₗᵢₘᵢₜ.

42. A device according to claim 33, wherein the second reforming catalyst of the detector device is provided as a component of said reforming catalyst connected in front of the fuel cells and used for reforming the fuel gas supplied to the fuel cells.
